(19) United States
(12) Patent Application Publication
(10) Pub. No.: US 2022/0284184 A1
(43) Pub. Date: Sep. 8, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Kiyoshi TASHIRO, Kanagawa (JP); Yoshihisa Matsuo, Kanagawa (JP); Atsushi Togo, Kanagawa (JP); Kazuya IImura, Kanagawa (JP)

(73) Assignee: FUJIFILM Business Innovation Corp., Tokyo (JP)

(21) Appl. No.: 17/752,148

(22) Filed: May 24, 2022

Related U.S. Application Data
(62) Division of application No. 16/391,574, filed on Apr. 23, 2019.

(30) Foreign Application Priority Data
May 1, 2018 (JP) 2018-088397
May 1, 2018 (JP) 2018-088398
May 1, 2018 (JP) 2018-088399

(51) Int. Cl. G06F 40/186; G06F 3/0482; G06F 9/451; G06F 3/0487; G06F 40/103

(52) U.S. Cl. CPC G06F 40/186; G06F 3/0482; G06F 9/451; G06F 3/0487; G06F 40/103

(57) ABSTRACT

An information processing apparatus includes: a specifying unit that specifies, from at least one document serving as a sample, input target information to be input; a converting unit that converts the specified input target information into a condition required for document processing; and a display controller that performs control to cause the condition to be displayed.

### CROSS-REFERENCE TO RELATED APPLICATIONS

This application is a Divisional Application of U.S. application Ser. No. 16/391,574 filed on Apr. 23, 2019, which is based on and claims priority under 35 USC 119 from Japanese Patent Application No. 2018-088397 filed May 1, 2018, Japanese Patent Application No. 2018-088398 filed May 1, 2018, and Japanese Patent Application No. 2018-088399 filed May 1, 2018, the disclosures of which are incorporated herein by reference in their entireties.

### BACKGROUND

### (i) Technical Field

The present disclosure relates to an information processing apparatus and a non-transitory computer readable medium.

### (ii) Related Art

In recent years, there has been proposed an information processing apparatus that supports user's work (see, e.g., JP-A-2014-186508).

The information processing apparatus described in JP-A-2014-186508 includes: an output information setting unit that sets information on an output that a user intends to obtain as a processing result by a processing module; an existing processing module retrieving unit that retrieves an existing processing module having an output that matches the information on the output set by the output information setting unit from a processing module/database in which the existing processing module is registered; and an existing processing module presenting unit that presents the existing processing module retrieved by the existing processing module retrieving unit to be selectable.

When the user himself/herself sets information on the output to be obtained as a processing result, it is necessary to understand and properly set the information, which is a burden on the user.

In some cases, data is transferred between plural modules so that the processing of data is facilitated. At this time, in the module of the transfer source, it is necessary to check whether the process is executed appropriately in the module of the transfer source so that the process can be executed in the next module.

In data processing, the user's convenience can be improved by making clear what to do next according to the state of the data.

### SUMMARY

Aspects of non-limiting embodiments of the present disclosure relate to providing an information processing apparatus and a non-transitory computer readable medium that reduce user's labor, compared to a case where the user himself/herself specifies and sets processing conditions.

Aspects of non-limiting embodiments of the present disclosure also relate to providing an information processing apparatus and a non-transitory computer readable medium that allow control to be performed in such a way that a function of executing a process necessary for a condition that a document should satisfy is displayed when the document is transferred between processes associated with each other.

Aspects of non-limiting embodiments of the present disclosure further relate to providing an information processing apparatus and a non-transitory computer readable medium that allow control to be performed in such a way that a function of executing a process necessary for a document is displayed to an operator in accordance with the current state of the document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a specifying unit that specifies, from at least one document serving as a sample, input target information to be input; a converting unit that converts the specified input target information into a condition required for document processing; and a display controller that performs control to cause the condition to be displayed.

### BRIEF DESCRIPTION OF THE DRAWINGS

Exemplary embodiments of the present disclosure will be described in detail based on the following figures, wherein:

FIG. 1 is a view illustrating an example of a configuration of an information processing apparatus according to an exemplary embodiment of the present disclosure;

FIG. 2 is a block diagram illustrating an example of a control system of the information processing apparatus illustrated in FIG. 1;

FIGS. 3A and 3B are views illustrating an example of a workplace information table;

FIGS. 4A to 4D are diagrams illustrating an example of a home screen and an example of an operation of creating a workplace in this order;

FIG. 5 is a diagram illustrating an example of a home screen and an example of an operation of connecting workplaces;

FIGS. 6A to 6D are diagrams illustrating an example of a home screen and an example of an operation of setting a transfer condition in this order;

FIG. 7 is a diagram illustrating an example of a work flow;

FIGS. 8A to 8E are diagrams illustrating an example of a workplace editing screen and an example of an operation of editing a workplace in this order;

FIGS. 9A to 9E are diagrams illustrating an example of a workplace screen and an example of an operation of executing an individual task in this order;

FIGS. 10A and 10B are diagrams illustrating an example of a workplace screen and an example of an operation of executing an application;

FIGS. 11A and 11B are diagrams illustrating an example of a workplace screen and an example of an operation of setting an automatic task;

FIG. 12 is a diagram illustrating an example of a workplace screen and an example of the operation of an automatic task execution;

FIGS. 13A and 13B are diagrams illustrating an example of a workplace screen and an example of an operation of setting an automatic application; and

FIG. 14 is a diagram illustrating an example of a workplace screen and an example of the operation of an automatic application execution.

### DETAILED DESCRIPTION

Hereinafter, an exemplary embodiment of the present disclosure will be described with reference to the accompanying drawings. Further, in each of the drawings, substantially the same constituent elements are denoted by the same reference numerals, and redundant descriptions thereof are omitted.

### Summary of Exemplary Embodiment

The information processing apparatus according to the exemplary embodiment includes: a specifying unit that specifies, from at least one document serving as a sample, input target information to be input; a converting unit that converts the specified input target information into a condition required for document processing; and a display controller that performs control to cause the condition to be displayed.

The term “document” refers to a material including a character or characters, a figure or figures, an image or images, a moving picture or pictures, a sound or sounds, or other information, or any combination thereof. Examples of the document include documents generated by applications such as a document creation program, a figure generating program, a table calculating program, and a document managing program.

### Exemplary Embodiments

Configuration of Information Processing System

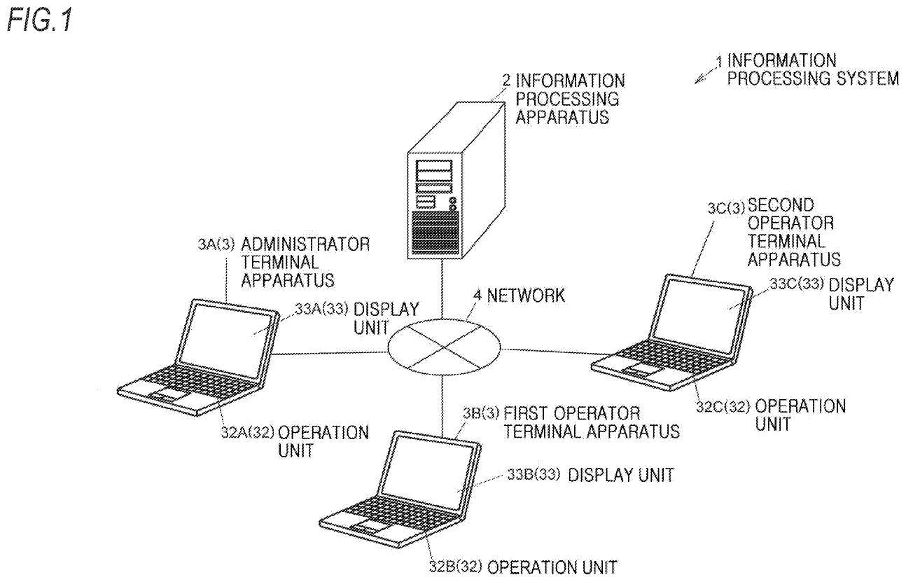

FIG. 1 is a view illustrating an example of a configuration of an information processing system according to an exemplary embodiment of the present disclosure. The information processing system 1 includes an information processing apparatus 2, a terminal apparatus used by an administrator having management authority (hereinafter, referred to as “administrator terminal apparatus 3A”), a terminal apparatus used by a general first operator having no management authority (hereinafter, also referred to as “first operator terminal apparatus 3B”), and a terminal apparatus used by a general second operator having no management authority (hereinafter, also referred to as “second operator terminal apparatus 3C”). The information processing apparatus 2, the administrator terminal apparatus 3A, the first operator terminal apparatus 3B, and the second operator terminal apparatus 3C are connected with each other via a network 4.

Hereinafter, when the administrator terminal apparatus 3A, the first operator terminal apparatus 3B, and the second operator terminal apparatus 3C are collectively referred to, these elements are simply referred to as a “terminal apparatus 3.” When the first operator terminal apparatus 3B and the second operator terminal apparatus 3C are collectively referred to, these elements are simply referred to as an “operator terminal apparatus 3.” Also, when the administrator, the first operator, and the second operator are collectively referred to, these elements are referred to simply as an “operator” or a “user.” When the first operator and the second operator are distinguished from the administrator, these elements are also referred to as a “general operator.”

The information processing apparatus 2 may be, for example, a personal computer, an image forming apparatus such as a multifunction machine, a tablet terminal, a multifunction mobile phone (smart phone), or the like.

This information processing apparatus 2 may be used, for example, to support the work of transferring a formal document among plural operators. The basic operations performed by the information processing apparatus 2 include the following, which will be described in detail later.
(1) An operation of constructing a series of works (hereinafter, also referred to as a “work flow”) by associating plural works with one another
(2) An operation of editing an environment in which tasks are performed for each work
(3) An operation of performing tasks for each work

In this regard, tasks are an example of document processing. The terminal apparatus 3 may use, for example, a personal computer, a tablet type terminal, a multifunction mobile phone (smart phone), or the like. The terminal apparatus 3 includes an operation unit 32 implemented by a keyboard, a mouse, or the like, and a display unit 33 implemented by a liquid crystal display, or the like.

The network 4 may be, for example, a local area network (LAN), the Internet, an intranet, or the like, and may be wired or wireless.

FIG. 1 shows a configuration example in which three terminal apparatuses 3 are provided. However, the number of the terminal apparatuses 3 is not limited to three, and one, two, or four or more terminal apparatuses may be provided.

Configuration of Information Processing Apparatus 2

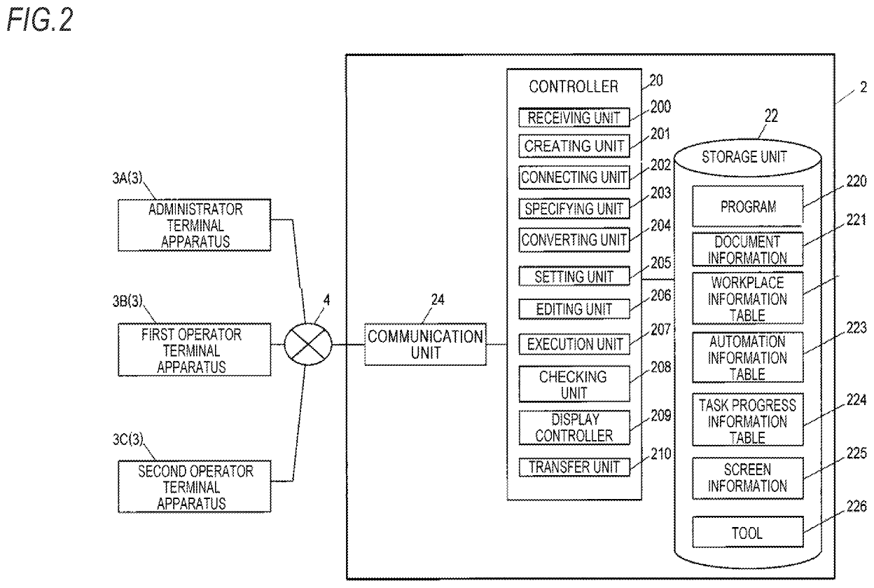

FIG. 2 is a block diagram illustrating an example of a control system of the information processing apparatus 2 illustrated in FIG. 1. As illustrated in FIG. 2, the information processing apparatus 2 includes a controller 20 that controls each unit, a storage unit 22 that stores various data, and a communication unit 24 that communicates with the terminal apparatus 3 via the network 4.

Controller 20

The controller 20 includes a central processing unit (CPU), an interface, and the like. The CPU operates in accordance with a program 220 recorded in the storage unit 22 so as to function as a receiving unit 200, a creating unit 201, a connecting unit 202, a specifying unit 203, a converting unit 204, a setting unit 205, an editing unit 206, an execution unit 207, a checking unit 208, a display controller 209, a transfer unit 210, and the like. The transfer unit 210 is an example of an outputting unit. The details of each of the units 200 to 210 will be described later.

Storage Unit 22

The storage unit 22 is configured with a read only memory (ROM), a random access memory (RAM), a hard disk, or the like and stores various data such as a program 220, document information 221, a workplace information table 222, an automation information table 223, a task progress information table 224, screen information 225, and a tool 226. Details of the workplace information table 222, the automation information table 223, and the task progress information table 224 will be described later.

The document information 221 is a record of attribute information, which indicates the attribute of a document, for each document. Examples of the attribute information include information that indicates an item or a column to be input (hereinafter, also referred to as a “field”), information that indicates the structure of data, character information that consists of characters or numerical values such as title, date and time, or item name, a seal mark (hereinafter, also referred to as “seal imprint information”), a logo mark that indicates a trade name or an organization name, figure information including a figure or a symbol such as a symbol mark representing qualification or standard, and positional information that indicates the position of the character information and the figure information in the document. The field is an example of the input item. As used herein, the term “field” is intended to include a template (hereinafter, also referred to as an “underlying form”), which includes a layout and a fixed portion constituting the base of a document.

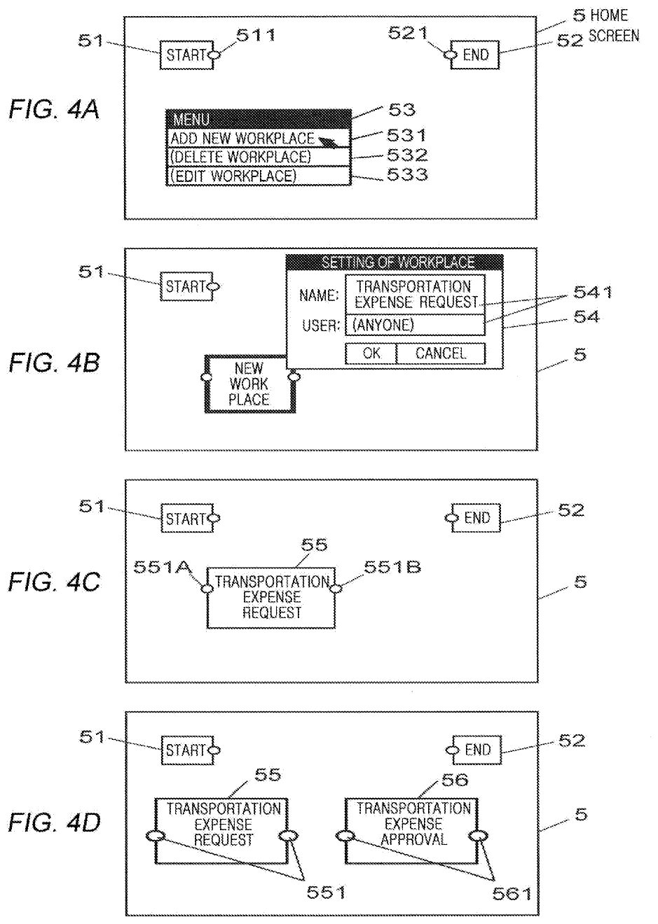

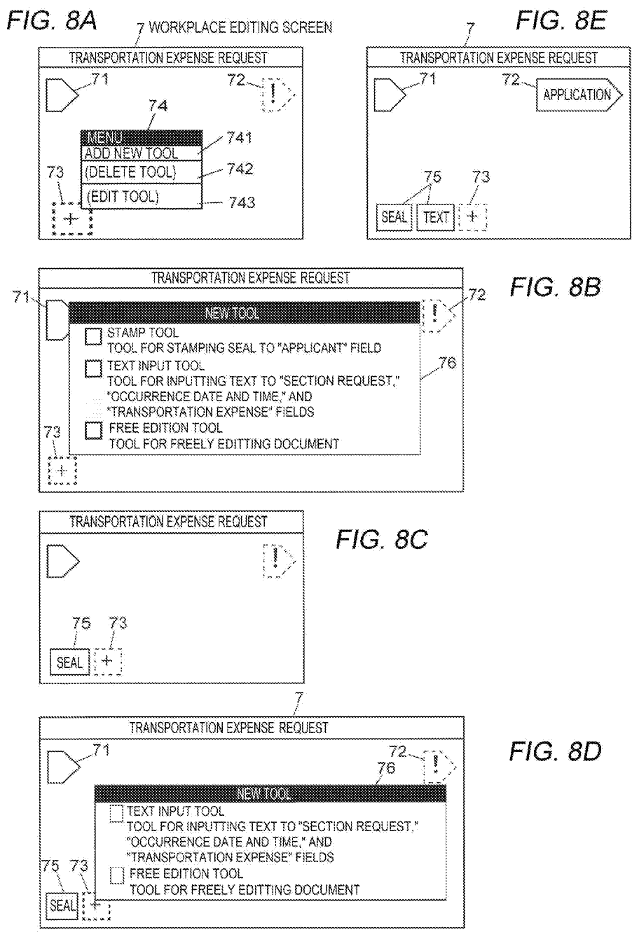

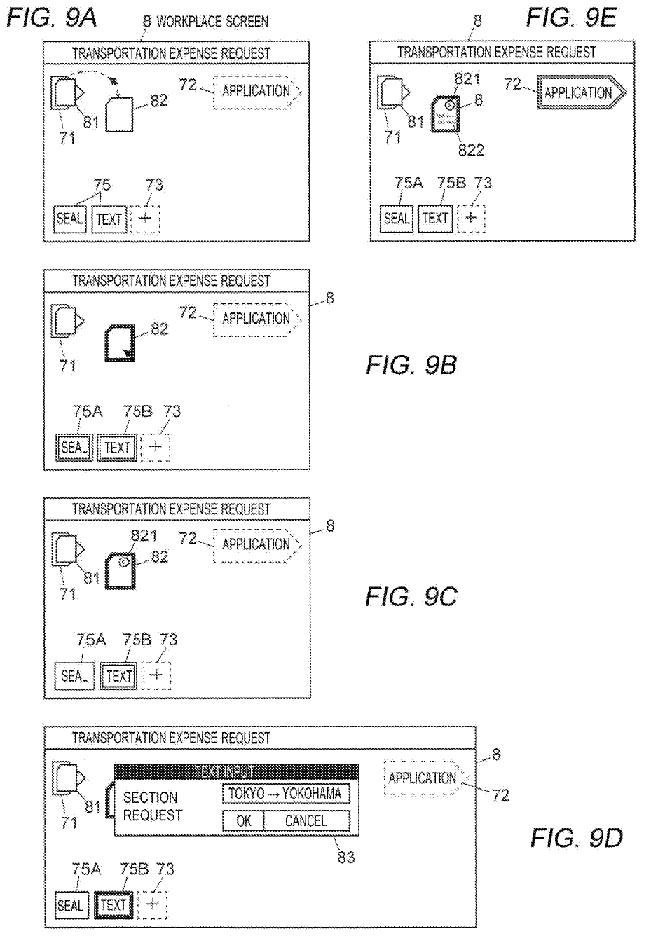

The screen information 225 is information indicating any of various screens, which is caused to be displayed on the display unit 33 of the terminal apparatus 3 by the display controller 209 (described later). Examples of the screen for the screen information 225 include a home screen 5 (see FIGS. 4A to 6D), a workplace editing screen 7 (see FIGS. 8A to 8E), a workplace screen 8 (see FIGS. 9A to 14), and the like. Details of each screen will be described later.

The tool 226 is a function of editing a document. Editing a document includes inputting (writing), modification, deletion, and the like. Specifically, the tool 226 is a function of executing individualized tasks that constitute a series of tasks for one work. Examples of the “individualized tasks” include an operation of attaching seal imprint information to a document (i.e., an operation of stamping a seal of electronic data), an operation of filling in items necessary for application, and the like. Examples of the tool include a stamping tool for attaching seal imprint information of a predetermined specific person, a text input tool for inputting a text designated by an operator into a predetermined field, a free edition tool for freely editing the document, and the like. The stamping tool and the text input tool are examples of an input function.

A series of tasks is an example of a series of processes. The tool is an example of a function of executing a process.

The text input tool is an example of a function of inputting predetermined information to a document.

The tool 226 may be added, deleted, and set by an operator. For example, the text input tool may be configured to input predetermined specific information into a predetermined field.

Each of Units 200 to 210

Next, details of each of the units 200 to 210 of the controller 20 will be described. The receiving unit 200 receives various types of information and signals transmitted from the terminal apparatus 3 via the network 4. The information received by the receiving unit 200 includes, for example, information on various operations of the operator with respect to the operation unit 32 of the terminal apparatus 3.

The creating unit 201 creates a new workplace. A workplace is an environment in which tasks for a predetermined specific unit of work (hereinafter, also referred to as a “unit work”) is performed. In the workplace, a predetermined task is performed on the document. The workplace includes, for example, an environment in which tasks for application work are performed to make a certain application, or an environment in which tasks for approval work are performed to approve requested contents (hereinafter, also referred to as “application contents”).

The connecting unit 202 connects one workplace with another workplace. Herein, the term “connect” refers to associating a work for one workplace with a work for another workplace. Specifically, the term “connect” refers to associating one workplace with another workplace such that the document is transferred from an upstream workplace to a downstream workplace. The task performed in the upstream workplace is an example of a first process. The task performed in the downstream workplace is an example of a second process. That is, the first process and the second process are associated with each other by connecting the upstream workplace to the downstream workplace. The task in the downstream workplace is executed in association with the task performed in the upstream workplace.

The term “upstream” refers to the side closer to the start side in the work flow, and the term “downstream” refers to the side closer to the end side in the work flow. For example, when an upstream workplace for application work and a downstream workplace for approval work are connected to each other, the document to which the application contents are input is transferred from the upstream workplace to the downstream workplace.

The specifying unit 203 specifies input target information, which is to be input, from a sample of a document (also simply referred to as a “sample document”), which is to be transferred between interconnected workplaces. The input target information includes field information that indicates a field and information that indicates contents input in the field (hereinafter, also referred to as “input content information”). The sample document is an example of a document serving as a sample.

Specifically, the specifying unit 203 acquires attribute information corresponding to the sample document from the document information 221 stored in the storage unit 22, and specifies field information and input content information according to the attribute information.

The sample document includes, for example, a specific type of document having an entry example input in a field (hereinafter, also referred to as a “post-input document”) or a document including only a template without any entry example input in at least one field (hereinafter, also referred to as a “pre-input document”). The post-input document includes a document having information input in some of fields or a document having information input in all fields.

One or more sample documents may be provided. Further, when there are plural sample documents, they include, for example, a combination of different entry examples of the same type (i.e., documents having the same template) or a combination of a post-input document and a pre-input document. The pre-input document is an example of a first document. The post-input document is an example of a second document.

When there is a single sample document, the specifying unit 203 specifies a field in the sample document, the underlying form of the sample document, the presence or absence of information input in the field (i.e., the presence or absence of input content information for each field), the presence or absence of seal imprint information, or the like. When there are plural sample documents, the specifying unit 203 further specifies common or different features among the plural sample documents of input content information specified for each field in addition to the example listed above.

The converting unit 204 converts the input target information specified by the specifying unit 203 into a condition necessary for the document to be transferred from an upstream workplace to a downstream workplace (hereinafter, also referred to as a “transfer condition”) for the upstream and downstream workplaces to be connected to each other. The transfer condition is an example of a condition that a document should satisfy. Alternatively, the converting unit 204 may convert the input target information into a candidate for a transfer condition that is actually used in a work flow, which allows the setting unit 205 (described later) to make setting based on the operator's operation or the like.

In this regard, the transfer condition is also referred as a “completion condition” required to complete the task in the upstream workplace or a “start condition” required to start the task in the downstream workplace. Hereinafter, descriptions will be given using the term “transfer condition” for convenience of explanation.

When a single sample document is provided, the converting unit 204 converts, into the transfer condition, for example, each of the information indicating the underlying form of the sample document, the information on the presence or absence of the input content information specified for each field, and the information on the presence or absence of the seal imprint information. In this regard, the condition of the underlying form is a condition for determining, based on the template, whether the document is the task target in the workplace. Herein, however, it is also handled as one of transfer conditions.

Transfer conditions include at least one of items, such as which field needs to contain input content information (i.e., a condition related to field information) and what input content information is provided by input (i.e., a condition related to input content information).

More specifically, when the specifying unit 203 specifies that input content information is input in a field, the converting unit 204 converts, into a transfer condition, some information input in the field, and at the same time, when the specifying unit 203 specifies that seal imprint information is attached, the converting unit 204 converts, into a transfer condition, the seal imprint information attached to the document.

In addition, when it is specified that input content information is input in a field, the converting unit 204 converts the input content information into a transfer condition. Transfer conditions related to input content information are classified into, for example, a “fixed value,” an “optional value,” and a “linked value.”

Herein, the term “fixed value” refers to input content information constantly fixed as a transfer condition. When the input content information is a fixed value, the converting unit 204 converts, into a transfer condition, the input content information itself input in the corresponding field. The transfer condition of a fixed value is an example of a first condition.

The term “optional value” refers to input content information optionally fixed as a transfer condition. When the input content information is an optional value, the converting unit 204 converts, into a transfer condition, some information input in the target field. The transfer condition of an optional value is an example of a second condition.

The term “linked value” refers to input content information that is determined in a linked manner as a transfer condition. When the input content information is a linked value, the converting unit 204 converts, into a transfer condition, information on seal imprint of a specific person or information related to predetermined specific information, such as specific date and time, which is input in the target field. The transfer condition of a linked value is an example of a third condition.

When input content information is associated with specific information, the converting unit 204 converts the input content information into a linked value. In other words, the converting unit 204 converts the input content information into a third condition, under which a transfer condition is satisfied when input content information related to the specific information is input in the target field. For example, when seal imprint information of an applicant is attached as input content information to a field which applicant's information will be filled in (hereinafter, also referred to as an “applicant field”), the converting unit 204 converts, into the condition, the seal imprint information of the applicant attached to the applicant field.

Further, when there are plural sample documents, the converting unit 204 converts the input content information into a transfer condition in accordance with common and different features among the plural sample documents of the input content information specified for each field, in addition to the conversion mentioned above.

Specifically, when the input content information specified for each field is common among plural sample documents, the converting unit 204 converts, into a transfer condition, the field in which the input content information is input, and also converts the input content information into a fixed value. In other words, the converting unit 204 converts the input content information into a first condition, under which a transfer condition is satisfied when the input content information is input in the field. Alternatively, when the input content information specified for each field differs among plural sample documents, the converting unit 204 converts the input content information into an optional value. In other words, the converting unit 204 converts the input content information into a second condition, under which a transfer condition is satisfied when some information (which may be the corresponding input content information) is input in the field.

Also, the converting unit 204 may convert a difference between pre-input and post-input documents into a transfer condition. Specifically, with respect to the field in which the input content information differs between the pre-input and post-input documents, the converting unit 204 may convert the difference into a second condition, under which a transfer condition is satisfied when some information is input in the field.

The setting unit 205 performs various settings based on the operator's operation. For example, when the converting unit 204 converts the input target information into candidates of the transfer condition, the setting unit 205 sets, as the transfer condition, the input target information that is selected based on the operator's operation among the candidates of the transfer condition converted by the converting unit 204. The setting unit 205 sets the type of the transfer condition based on the operator's operation. The setting unit 205 also sets the input content information in the tool based on the operator's operation.

Further, the setting unit 205 associates the set transfer condition with the information indicating the workplace to record the associated transfer condition in the workplace information table 222 of the storage unit 22. Also, in the present specification, the term “record” is used when information is written in a table, and the term “store” is used when information is written in the storage unit 22.

The editing unit 206 edits the workplace. Herein, the expression “editing of the workplace” indicates constructing a series of tasks related to the unit task by combining individual subdivided tasks.

The execution unit 207 individually executes a series of tasks constructed by the editing unit 206 with respect to the document. Specifically, the execution unit 207 executes the corresponding individual tasks by activating the tool 226 stored in the storage unit 22. Further, the execution unit 207 records the completion of the task in the task progress information table 224 of the storage unit 22.

The checking unit 208 checks whether a series of tasks constructed by the editing unit 206 is in a state capable of satisfying the transfer conditions for the workplace (hereinafter, also referred to as “task consistency”) and whether the document in which the task is performed by the execution unit 207 satisfies the transfer conditions.

The expression “capable of satisfying the transfer conditions” indicates that the series of tasks constructed by the editing unit 206 includes the tasks required from the start to the end of one unit of work. The expression “capable of satisfying the transfer conditions” implies that workplaces are connected to form one work flow from the start to the end. Specifically, the state “capable of satisfying the transfer conditions” corresponds to a state in which tools for executing the necessary tasks from the start to the end of one unit of work are selected without lack as described later.

The display controller 209 controls the display unit 33 of the terminal apparatus 3 to display the transfer condition converted by the converting unit 204. As described above, the display controller 209 may control the display of the transfer condition as one of the candidates. The display controller 209 also controls the display of a candidate list of tools necessary for satisfying the transfer condition based on the workplace information table 222. Further, the display controller 209 controls the display unit 33 of the terminal apparatus 3 to display various screens. In the following description, the phrase “controls the display unit 33 of the terminal apparatus 3 to display” is simply referred to as “displays.” The transfer unit 210 transfers the document from the upstream workplace to the downstream workplace connected thereto.

Table of Various Pieces of Information

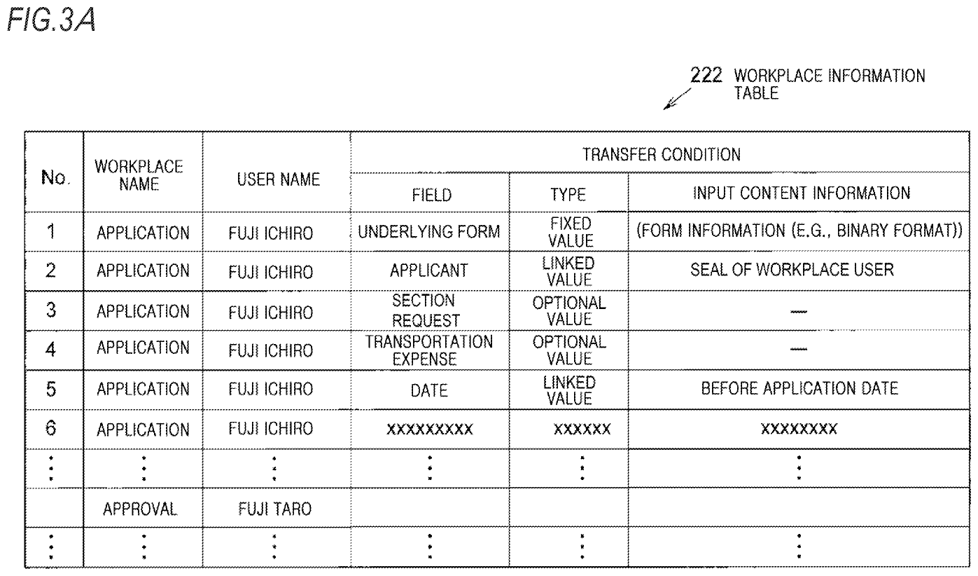

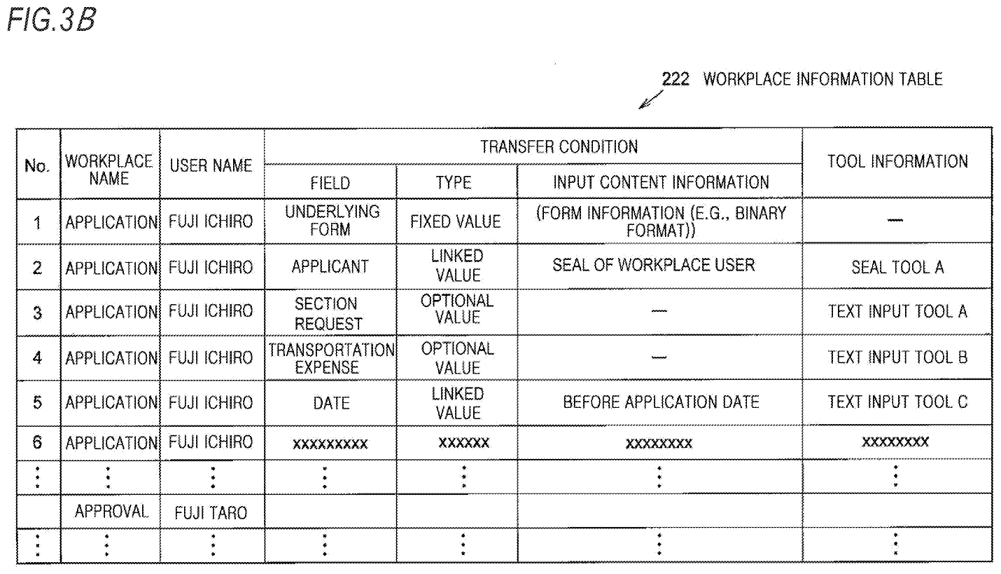

FIGS. 3A and 3B are views illustrating an example of a workplace information table 222. The workplace information table 222 is a record of workplace transfer conditions for each workplace. Specifically, information identifying the workplace and the transfer conditions set by the setting unit 205 are recorded in association with each other in the workplace information table 222.

A “workplace name” column, a “user name” column, and a “transfer condition” column are provided in the workplace information table 222 illustrated in FIG. 3A. A “workplace name” column, a “user name” column, a “transfer condition” column, and a “tool information” column are provided in the workplace information table 222 illustrated in FIG. 3B. A “field” column, a “type” column, and an “input content information” column are further provided in the “transfer condition” column. Information that identifies workplace, such as workplace name, is recorded in the “workplace name” column. The workplace information table 222 is an example of association information that associates the transfer conditions with tools.

Information that identifies field, such as field name related to transfer condition is recorded in the “field” column. Information that identifies operator, such as the name of the user who uses the workplace, is recorded in the “user name” column. A user ID may be recorded instead of the user name. Information indicating whether the input content information is a fixed value, an optional value, or a linked value is recorded for each field in the “type” column. The “input content information” records specific information for a transfer condition. Further, when “optional value” is recorded in the “type” column, information indicating no setting of input content information, such as “-” is recorded in the “input content information” column.

Tools necessary for satisfying the transfer conditions are recorded in association with the field in the “tool information” column. For example, a seal tool is applicable to the field related to “applicant,” and a text input tool is applicable to the field in which a text is to be input, such as a field related to “section request” or “expense request.” Further, as illustrated in FIGS. 3A and 3B, tools in which different pieces of input content information are recorded as parameters according to the reception conditions may be separately set, such as “Tool A,” “Tool B,” and “Tool C.”

The automation information table 223 is a record of tasks that are automated (described later) for each workplace. Specifically, for example, information identifying the workplace, information identifying the operator, and information indicating the automated tasks are recorded in association with each other in the automation information table 223.

The task progress information table 224 is a record of the progress of tasks for each workplace. The task progress corresponds to, for example, information that indicates which task has been performed in the document at the corresponding workplace. In the task progress information table 224, for example, information identifying the workplace, information indicating the document, and information indicating the task progress are recorded in association with each other.

Operation of Exemplary Embodiment

Next, an example of the operation of the information processing apparatus 2 will be described with reference to FIGS. 4A to 10B in accordance with the operation of a screen. Hereinafter, the operation will be described in detail by dividing the operation into three steps, (1) an operation of constructing a work flow, (2) an operation of editing a workplace, and (3) an operation of executing a task.

In the following description of the operation, a series of tasks consisting of an application work and an approval work (e.g., a work flow) will be described as an example. In addition, as an example of the content of the application, the operation in the application task of applying for transportation expenses will be mainly described. An environment in which the task related to the application task is performed is also referred to as a first workplace, and an environment in which the task related to the approval task is performed is also referred to as a second workplace. When the first workplace and the second workplace are collectively referred to, these elements are simply referred to as a “workplace.” Also, a person who performs the application task (i.e., applicant) is referred to as a first operator, and a person who performs the approval task (i.e., approver) is referred to as a second operator.

(1) Construction of Work Flow

The construction of a work flow includes the creation of a workplace, the connection of the created workplace, and the setting of the transfer conditions between the workplaces connected to each other. Hereinafter, as a specific example, the creation of the first workplace and the second workplace, the connection of the first workplace and the second workplace, the setting of the transfer conditions between the first workplace and the second workplace will be described with reference to FIGS. 4A to 4D. Further, in the construction of the work flow, the term “operation” refers to an operation performed by the administrator on an operation unit 32A of the administrator terminal apparatus 3A. Unless otherwise stated, the term “operator” refers to the administrator.

Creation of Workplace

FIGS. 4A to 4D are diagrams illustrating an example of a home screen. As illustrated in FIG. 4A, the home screen 5 includes a first icon 51 that indicates the start of the work flow and a second icon 52 that indicates the end of the work flow. In addition, an icon refers to an operator that is displayed by characters, figures, symbols, or the like.

The first icon 51 includes a connector 511 that connects another icon to the first icon 51. The second icon 52 includes a connector 521 that connects another icon to the second icon 52. Further, the home screen 5 includes a first menu screen 53 as a sub-screen. The first menu screen 53 includes, for example, a workplace addition button 531 that newly adds a workplace, a workplace deletion button 532 that deletes a workplace, a workplace editing button 533 that edits a workplace, and the like.

When the receiving unit 200 receives an operation on the workplace addition button 531, the display controller 209 sets the name of the workplace and the like on the home screen 5 as illustrated in FIG. 4B, and also creates a workplace creation screen 54 that creates a workplace based on the set information. For example, an input column 541 that inputs the name of the workplace, the name of the user to be used, and the like are provided in the workplace creation screen 54.

When the receiving unit 200 receives the information input to the workplace creation screen 54, the creating unit 201 creates the first workplace based on the input information. When the first workplace is created, the display controller 209 displays a third icon 55 that represents the first workplace on the home screen 5 as illustrated in FIG. 4C (see “Transportation Expense Request” in FIG. 4C).

The third icon 55 includes an upstream connector 551A that connects another icon on the upstream side, and a downstream connector 551B that connects another icon on the downstream side. The upstream and downstream connectors 551A and 551B may be generically and simply referred to as “connectors 551.” Hereinafter, other icons are treated in the same manner.

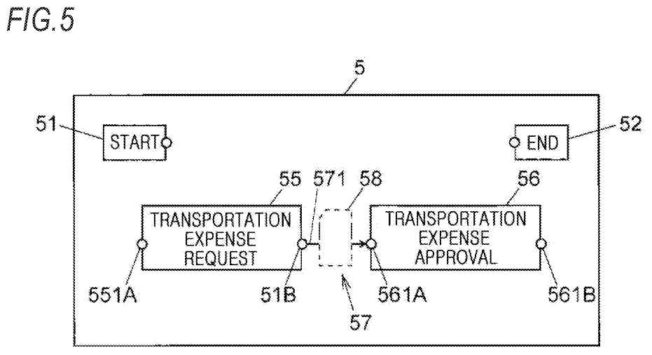

The second workplace is also created in the same manner as the first workplace. That is, the display controller 209 displays the workplace creation screen 54 on the home screen 5 in accordance with the operation on the workplace addition button 531, the creating unit 201 creates the second workplace in accordance with the information input to the workplace creation screen 54, and the display controller 209 displays a fourth icon 56 which represents the second workplace and includes two connectors 561 (561A, 561B; see FIG. 5) on the home screen 5, as illustrated in FIG. 4D.

Connection of Workplace

FIG. 5 is a diagram illustrating an example of the home screen 5 and an example of an operation of the workplace addition button 531. When the receiving unit 200 receives an operation of connecting the first workplace and the second workplace, the connecting unit 202 connects the first workplace and the second workplace.

The operation of connecting the workplaces with each other corresponds to, for example, starting the dragging of a cursor around the downstream connector of the icon related to the upstream workplace and ending the dragging of the cursor around the upstream connector of the icon related to the downstream workplace, or the like.

Specifically, as illustrated in FIG. 5, when the receiving unit 200 starts dragging the cursor around the downstream connector 551B of the third icon 55 displaying the first workplace and ends dragging the cursor around the upstream connector 561A of the fourth icon 56 displaying the second workplace, the connecting unit 202 connects the first workplace and the second workplace with each other. Further, although not illustrated, the display controller 209 may cause the downstream connector 551B to be displayed in a highlighted manner during the dragging of the cursor.

When the first workplace and the second workplace are connected with each other, the display controller 209 displays a connection symbol 57 indicating that a third icon 55 displaying the first workplace and a fourth icon 56 displaying the second workplace are connected with each other, on the home screen 5, as illustrated in FIG. 5.

As an example of the connection symbol 57, the display controller 209 may display an arrow 571 in which the downstream connector 551B of the third icon 55 is the starting point and the upstream connector 561A of the fourth icon 56 is the ending point.

In addition, the display controller 209 displays a document symbol 58 that indicates a document to be transferred between the interconnected workplaces. When the transfer condition between the workplaces is not set, the display controller 209 may display the document symbol 58 in a display mode indicating that the transfer condition is not set (e.g., a broken line, etc.).

Setting of Transfer Condition

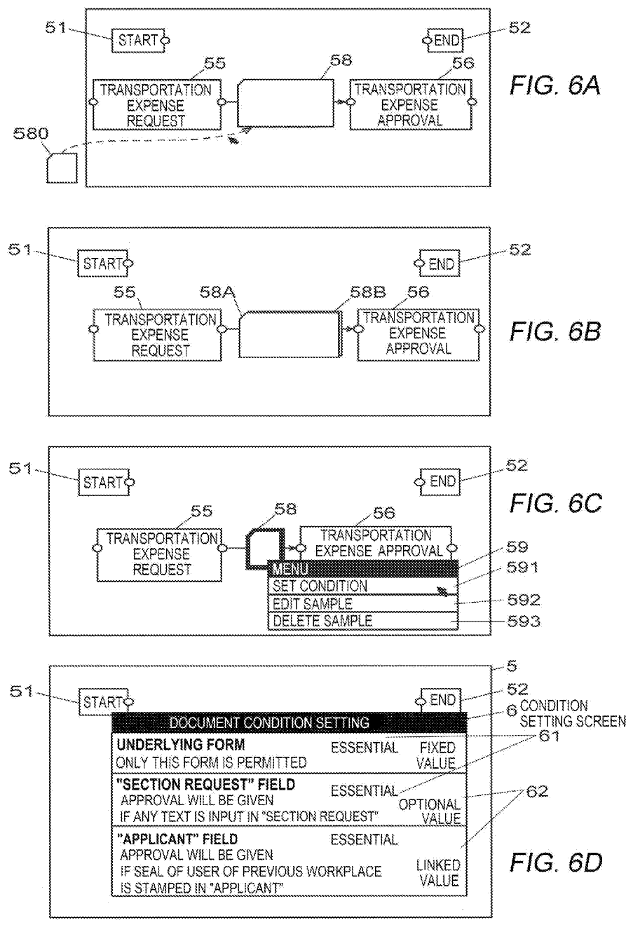

FIGS. 6A to 6D are diagrams illustrating an example of the home screen 5 and an example of an operation of setting the transfer condition. When the receiving unit 200 receives an operation of designating a sample document, the display controller 209 may display the document symbol 58 in a display mode indicating that the sample document is designated. As illustrated in FIG. 6A, the display controller 209 may change, for example, the display mode of the document symbol 58 from a broken line to a solid line.

For example, as illustrated in FIG. 6A, the operation of designating the sample document corresponds to, for example, the operation of starting the dragging of the cursor from a state where the cursor is located around a sample document symbol 580 indicating the sample document outside the home screen 5 and ending the dragging of the cursor around the document symbol 58 in the home screen 5.

Further, when plural sample documents are designated, the display controller 209 may cause plural document symbols 58A and 58B to be displayed as illustrated in FIG. 6B.

Next, the display controller 209 displays a second menu screen 59 as illustrated in FIG. 6C. The second menu screen 59 includes, for examples, a condition setting button 591 that sets the transfer conditions of the workplace, a sample editing button 592 that rewrites the content of the designated sample document, a sample deletion button 593 that cancels the designation of the sample document, and the like.

When the receiving unit 200 receives an operation on the condition setting button 591, the specifying unit 203 specifies the field information and the input content information of the designated sample document. When the specifying unit 203 specifies the field information and the input content information of the corresponding sample document, the converting unit 204 converts the information specified by the specifying unit 203 into a transfer condition.

Next, the display controller 209 displays a condition setting screen 6 that allows the operator to set the transfer conditions of the workplace. As illustrated in FIG. 6D, the field specified by the specifying unit 203 and the transfer condition converted by the converting unit 204 are displayed in association with each other on the condition setting screen 6.

In addition, the condition setting screen 6 includes a first selection button 61 that allows the operator to select whether each field is set as one of the transfer conditions, and a second selection button 62 that allows the operator to select the type of the transfer condition for the input content information of the corresponding field when the corresponding field is selected to be set as one of the transfer conditions.

The first selection button 61 allows selection of the corresponding field as “required” in which the corresponding field is set as one of the transfer conditions or “arbitrary” in which the corresponding field is not set as one of the transfer conditions, for example, by pulling down or the like. Further, the second selection button 62 allows selection of the above-described “fixed value,” “optional value” or “linked value,” for example, by pulling down or the like.

When the receiving unit 200 receives the information input from the condition setting screen 6, the setting unit 205 sets the transfer condition based on the information input from the condition setting screen 6, and records the set transfer condition in the workplace information table 222 of the storage unit 22 in association with the information identifying the workplace.

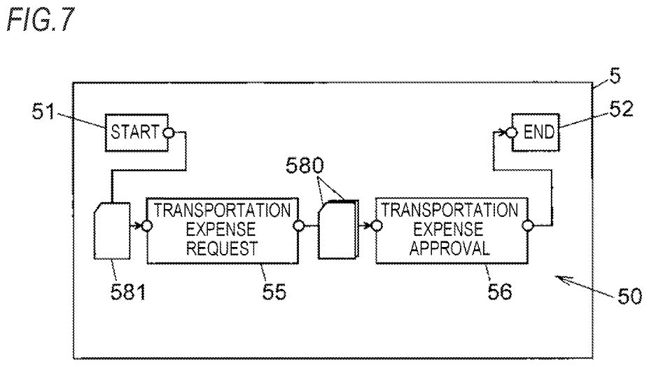

FIG. 7 is a diagram illustrating an example of a work flow; In the same way as the connection between the first workplace and the second workplace, when the connection between the first workplace and “start” and the connection between the second workplace and “end” are set and the respective transfer conditions for the first and second workplaces are set, a series of tasks which is constructed by associating the application task corresponding to the first workplace and the approval task corresponding to the second workplace with each other, that is, the work flow 50, is completed as illustrated in FIG. 7.

Further, a document symbol 581 displayed between the third icon 55 indicating the first workplace and the first icon 51 indicating the start is a symbol indicating a document which is a task target in the first workplace. A document which becomes a task target in the first workplace corresponds to, for example, a document related to the application task.

Also, the transfer conditions of the second workplace regarding the approval task are set in the same manner as the first workplace. That is, the specifying unit 203 specifies the field information and the input content information from the sample document for which the specifying unit 203 is designated, the converting unit 204 converts such information into the transfer condition, and the setting unit 205 sets the transfer condition based on the operator's operation.

(2) Editing of Workplace

FIGS. 8A to 8E are diagrams illustrating an example of a workplace editing screen. Hereinafter, the editing of the first workplace related to the application task will be described as an example. For convenience of explanation, the first workplace is also simply referred to as a “workplace.” The “operator” is described on the assumption of a general operator (particularly, the first operator), but this operation may be performed by the administrator.

When the receiving unit 200 receives an operation on the workplace editing button 533 (see FIG. 4A), the display controller 209 displays the workplace editing screen 7 as illustrated in FIG. 8A.

The workplace editing screen 7 includes, for example, a start symbol 71 that starts a task on a document in the workplace, a transfer symbol 72 that activates the transfer unit 210 to transfer the document to the associated workplace, a task symbol 75 that represents an individual task content constituting a series of tasks performed in the workplace (i.e., the contents of the tool) and also instructs execution of each task (see FIG. 8C), a task configuration editing symbol 73 that edits a series of task configurations, and the like. The shape of each symbol is an example, and is not limited to those illustrated in FIGS. 8A to 8E. Editing of a series of task configurations is performed by adding, deleting, and editing the above-described tools, which will be described in detail later. The transfer symbol 72 is an example of an execution indicator. The task configuration editing symbol 73 is an example of a selector. Further, the transfer symbol 72 is an example of an output controller, and the task symbol 75 is an example of information indicating an execution indicator and a function.

When the consistency of the task is not satisfied or when the document does not satisfy the transfer condition, the display controller 209 may display the transfer symbol 72 in a display mode indicating that the consistency of the task is not satisfied or the document does not satisfy the transfer condition. As illustrated in FIG. 8A, for example, the display controller 209 may attach an exclamation point symbol or the like to the transfer symbol 72, or may display the transfer symbol 72 with a broken line or the like.

When the receiving unit 200 receives an operation on the task configuration editing symbol 73, the display controller 209 displays a third menu screen 74 as illustrated in FIG. 8B. The third menu screen 74 includes, for example, a tool addition button 741 that adds a tool, a tool deletion button 742 that deletes a tool, a tool editing button 743 that edits a tool, and the like.

When the receiving unit 200 receives an operation on the tool addition button 741, the display controller 209 displays a task addition screen 76 as illustrated in FIG. 8B. A list of tools displayed on the task addition screen 76 may be selected by an operator, for example, in a box or the like.

Specifically, the display controller 209 refers to a field related to the transfer condition recorded in the workplace information table 222 of the storage unit 22, and displays a list of candidates for the tool that may perform a task on the field recorded as the transfer condition (hereinafter, also referred to as a “list”) on the task addition screen 76. The phrase “tool that may perform a task on the field” corresponds to, for example, a seal tool for the field related to the “applicant,” and corresponds to, for example, a text input tool in the field related to the “section request” or the “expense request.” Further, the tool that may perform a task on the field or the tool necessary for satisfying the transfer condition may be stored in the storage unit 22 in association with the field in advance, for example, in the workplace information table 222 or the like.

The receiving unit 200 receives an operation of selecting a specific tool by the operator from the list of the above-described tools. When the receiving unit 200 receives an operation of selecting a seal tool, the editing unit 206 adds a task of attaching seal imprint information as an individual task that constitutes a series of tasks of the workplace. Further, the display controller 209 displays a task symbol 75 related to a “seal” as illustrated in FIG. 8C.

When the receiving unit 200 further receives an operation on the tool addition button 741, the display controller 209 displays the task addition screen 76 as illustrated in FIG. 8D. In this case, the display controller 209 may be configured not to display a tool related to the task already added as an individual task that constitutes a series of tasks of the workplace (specifically, the task of attaching the seal imprint information).

For example, when the receiving unit 200 receives an operation of selecting a text input tool, the editing unit 206 further adds a task of inputting text as a series of tasks that constitutes a series of tasks of the workplace. Further, the display controller 209 displays a task symbol 75 related to “text” as illustrated in FIG. 8E. Also, the display controller 209 may display the task symbol 75 side by side in accordance with the execution order of the task.

The editing unit 206 may perform editing to replace the order of the individual tasks that constitutes a series of tasks in accordance with the operator's operation. In this case, the display controller 209 may alternatively display the order of the task symbols 75 in accordance with the order edited by the editing unit 206.

The checking unit 208 checks the consistency of the task. When the consistency of the task is satisfied, the display controller 209 may display the transfer symbol 72 and the task configuration editing symbol 73 in a display mode indicating that the consistency of the task is satisfied. Specifically, the display controller 209 may cause the transfer symbol 72 and the task configuration editing symbol 73 to be displayed in a highlighted manner. More specifically, as illustrated in FIG. 8E, for example, the display controller 209 may change display of the exclamation point symbol on the transfer symbol 72 to display of character information indicating “application,” change display of broken lines to display of solid lines, or cause both of them. Further, the display controller 209 may cause the task configuration editing symbol 73 to be displayed with changed line width. The checking unit 208 may preferably check the task consistency every time after the tool is added, deleted, or edited.

The editing of the first task related to the application task has been described above, but the editing of the second workplace related to the approval task will be described in the same manner. That is, in accordance with the operator's operation, the editing unit 206 constructs a series of tasks related to the approval task by adding individual tasks, and the checking unit 208 checks the consistency of the tasks.

(3) Execution of Task

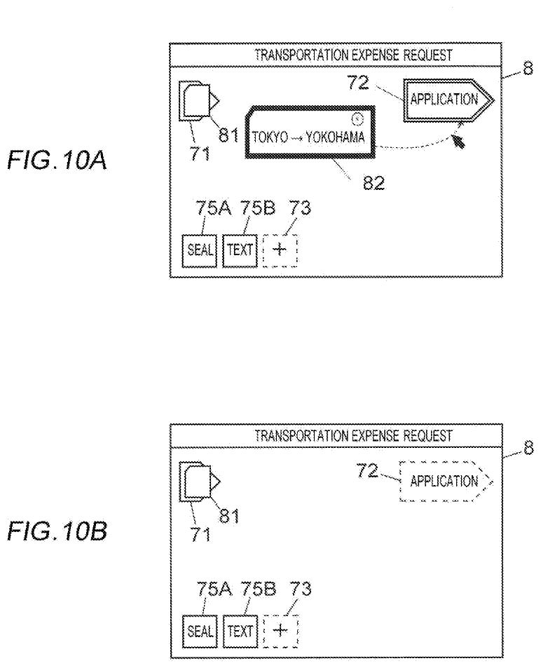

Execution of a task involves an execution of individual tasks on the document and an execution of document transfer (specifically, application). Hereinafter, the execution of the task related to the application task will be described with reference to FIGS. 9A to 9E and FIGS. 10A and 10B. For the convenience of explanation, the first workplace related to the application task is also simply referred to as a “workplace.” In addition, the term “operator” refers to the first operator (applicant) unless otherwise stated.

Execution of Individual Tasks

FIGS. 9A to 9E are diagrams illustrating an example of a workplace screen and an example of an operation of executing an individual task in this order; As illustrated in FIG. 9A, the workplace screen 8 includes, for example, a start symbol 71, a transfer symbol 72, a task symbol 75, and an application document symbol 81 that indicates a document related to the application task to be a task target in the workplace (hereinafter, also referred to as an “application document”), and the like. The application document is, for example, a pre-input document, but may be a post-input document in which information is input to a portion or all of the fields.

When there are plural application documents, the display controller 209 may cause plural application document symbols 81 to be displayed or may cause the number of application documents to be displayed. Further, since the start symbol 71, the transfer symbol 72, and the task symbol 75 are the same as the start symbol 71, the transfer symbol 72, and the task symbol 75 of the above-described workplace editing screen 7, detailed descriptions thereof will be omitted.

When the receiving unit 200 receives an operation of starting the application task, document data related to the application document is generated, and the display controller 209 displays a document data symbol 82 indicating the generated document data as illustrated in FIG. 9B. As illustrated in FIG. 9A, the operation of starting the application task corresponds to, for example, the operation of starting the dragging of a cursor from a state where the cursor is located around the application document symbol 81 and ending the dragging thereof in a state where the cursor is located at a predetermined position in the workplace.

The display controller 209 also refers to the task information table 222 and the task progress information table 224 of the storage unit 22, and displays the task symbol 75 related to the task that is required to be executed for the generated document data. That is, the display controller 209 displays the task symbol 75 related to the task that is required in the current state of the document based on the transfer condition, and the information indicating the process executed in the document recorded in the task progress information table 224. In this case, the display controller 209 may display the task symbol 75 related to the task that has not yet been executed in the document, in a display mode indicating that the task has not yet been executed. For example, when the generated document data is a pre-input document, as illustrated in FIG. 9B, the display controller 209 may display a task symbol 75A related to “seal” and a task symbol 75B, for example, in a double frame.

When the receiving unit 200 receives an operation on the task symbol 75A related to the “seal,” the execution unit 207 activates the seal tool and executes a task of attaching seal imprint information to the application document. When the task of attaching the seal imprint information is completed, the execution unit 207 records completion of the task of attaching the seal imprint information to the task progress information table 224.

Further, the display controller 209 may display the document data symbol 82 in a display mode indicating that the task of attaching the seal imprint information is completed. Specifically, as illustrated in FIG. 9C, the display controller 209 may display a seal symbol 821 indicating that the task of attaching the seal imprint information to the document data symbol 82 is completed, for example, in a thumbnail display mode. The thumbnail is an example of image information. The display controller 209 may return the display mode of the task symbol 75A related to the completed task of attaching the seal imprint information from a double frame to a single frame.

Further, the display controller 209 may display a checking screen (not illustrated) that checks with the operator regarding whose seal imprint information is to be attached when the type of the transfer condition in the “applicant” field is “an optional value.”

Next, when the receiving unit 200 receives an operation on the task symbol 75B related to the “text,” the execution unit 207 activates the text input tool to execute a task of inputting information to a necessary field. Specifically, the execution unit 207 executes a task of inputting information for the field recorded as a transfer condition in the workplace information table 222 of the storage unit 22.

When the input content information is set in advance in the tool, the execution unit 207 may input the preset input content information to the corresponding field. In this case, the checking unit 208 may check whether the transfer condition is satisfied by inputting the preset input content information. Further, the input content information may be changed by the operator's operation.

The execution unit 207 may refer to the workplace information table 222 of the storage unit 22 and uniformly input the input content information recorded as the “fixed value” to the corresponding field. For example, as illustrated in FIG. 3A or 3B, when the “user's seal of the workplace” is recorded as the “linked value” in the applicant field of the workplace information table 222 (see “applicant” in the “field” of FIG. 3A or 3B), the execution unit 207 may activate the seal tool and attach the seal imprint information about the user of the workshop to the applicant field. In other words, the specific information input by various tools is associated with transfer conditions (more specifically, types of transfer conditions). That is, various tools are activated by the execution unit 207 to input predetermined specific information associated with the transfer condition.

Further, the execution unit 207 may refer to the workplace information table 222 of the storage unit 22 and uniformly input the associated specific information to the field recorded as the “linked value.” The execution unit 207 may refer to the workplace information table 222 of the storage unit 22 and input the information input by the operator's operation to the field recorded as the “optional value.” In this case, the setting unit 205 sets the input content information to various tools based on the information input by the operator's operation. Further, the display controller 209 may, for example, check with the operator regarding whether to input information, and cause a screen (not illustrated) to be displayed, in which information is to be input.

The display controller 209 displays a text input screen 83. This text input screen 83 is a screen in which the input content information is input to, for example, the field required for the application (e.g., “section request,” etc.) for the operator. When there are plural fields that require input, the display controller 209 may continuously and repeatedly allow display of a screen, in which the input content information is input to the next field (e.g., “transportation expenses,” etc.) after the task of inputting the input content information to one field is completed, until the input content information is input to all of the fields necessary for the application, or may cause an input column related to plural fields to be displayed in a list form on a single screen.

When the task of inputting text is completed, the execution unit 207 records the completion of the text inputting task in the task progress information table 224. The display controller 209 may also display the document data symbol 82 in a display mode indicating that the task of inputting the text is completed. Specifically, as illustrated in FIG. 9E, the display controller 209 may display a text symbol 822 indicating that the task of inputting text to the document data symbol 82 is completed, for example, in a thumbnail display mode. Further, the display controller 209 may return the display mode of the task symbol 75B related to the completed “text” from a double frame to a single frame.

The checking unit 208 checks whether the document satisfies the transfer condition recorded in the workplace information table 222 of the storage unit 22. When the document satisfies the transfer condition, the display controller 209 may display the transfer symbol 72 by changing it to a display mode indicating that the symbol becomes selectable, as illustrated in FIG. 9E. Specifically, the display controller 209 may display the transfer symbol 72 by changing it to a double frame or the like. Further, the checking unit 208 may preferably check whether the document meets the termination condition every time after each task is executed by the execution unit 207.

Execution of Application

FIGS. 10A and 10B are diagrams illustrating an example of the workplace screen 8 and an example of an operation of executing an application. When the receiving unit 200 receives an operation of executing the application, the transfer unit 210 transfers the document from the workplace to another workplace associated with the workplace. As illustrated in FIG. 10A, the operation of executing the application corresponds to, for example, starting the dragging of a cursor from a state where the cursor is located around the document data symbol 82 and ending the dragging of the cursor in a state where the cursor is located around the transfer symbol 72. The display controller 209 may display the display mode of the transfer symbol 72 by changing it from a double frame to a broken line frame, as illustrated in FIG. 10B.

Specifically, the transfer unit 210 transfers the document to the second workplace related to the approval task, which is the next workplace, in the first workplace related to the application task, according to the work flow 50 (see FIG. 7). The document transferred to the second workplace is executed by a second operator (approver) with respect to a predetermined approval task by an operation performed on an operation unit 32B of the second operator terminal apparatus 3B.

Modification 1

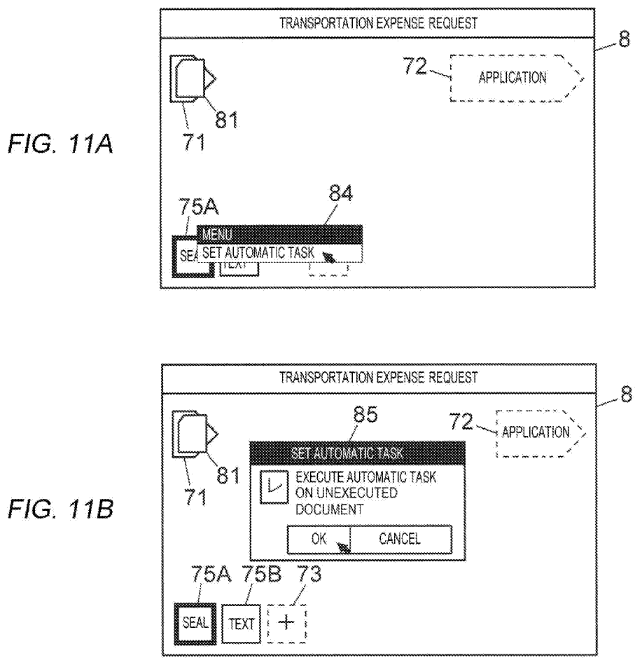

FIGS. 11A and 11B are diagrams illustrating an example of the workplace screen 8 and an example of an operation of setting an automatic task. The setting of the automatic task indicates that the individual tasks constituting a series of tasks are set to be executed automatically and individually. Further, the term “automatic” indicates that even when the operator does not instruct the execution of the task, that is, even when the receiving unit 200 does not receive an operation on the task symbol 75 by the operator, the execution unit 207 executes the task related to the task symbol 75A.

When the receiving unit 200 receives the menu display operation of the task symbol 75 for a specific task (e.g., the task symbol 75A related to the “seal”), the display controller 209 displays a fourth menu screen 84 as illustrated in FIG. 11A. Next, when the receiving unit 200 receives an operation for the automatic task setting button displayed on the fourth menu screen 84, as illustrated in FIG. 11B, the display controller 209 displays an automatic task setting screen 85 that causes the operator to set whether the task related to the task symbol 75 is automatically executed. Further, the setting unit 205 records information about automation of the set task in the automation information table 223 of the storage unit 22 in association with information identifying the workplace and information identifying the operator.

In addition, although not illustrated, a portion or all of individual tasks that constitute a series of tasks may be set to be automatically executed.

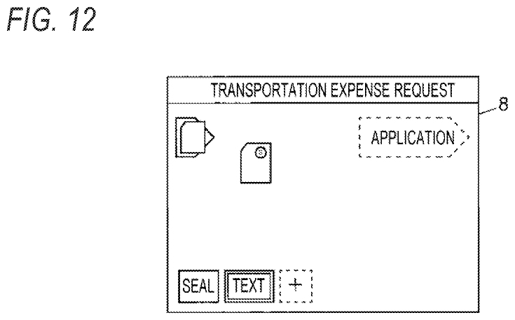

FIG. 12 is a diagram illustrating an example of the workplace screen 8 and an example of the operation of an automatic task execution. The phrase “automatic task execution” refers to performing an automatic task. When the receiving unit 200 receives an operation of starting the above-mentioned application task, even when there is no operation on the task symbol 75A related to the “seal,” the execution unit 207 activates the seal tool and executes an operation of attaching the seal imprint information to the application document. Specifically, the execution unit 207 refers to information on automation recorded in the automation information table 223 of the storage unit 22, and when there is an automated task, the execution unit 207 executes the corresponding tool and executes the task. In other words, the execution unit 207 activates various tools and executes a corresponding task without an instruction for the task symbol 75A.

In this example, the execution unit 207 has performed the task of attaching the seal imprint information as a trigger that the receiving unit 200 has received the operation of starting the application task. However, the start of the application task may not necessarily be a trigger, and, for example, the point that a specific task is executed may be used as a trigger.

As illustrated in FIG. 12, the display controller 209 may display a seal symbol 821 indicating the completion of the task of attaching the seal imprint information to the document data symbol 82, and display returning the display mode of the task symbol 75A related to the completed task of attaching the seal imprint information from a double frame to a single frame.

Modification 2

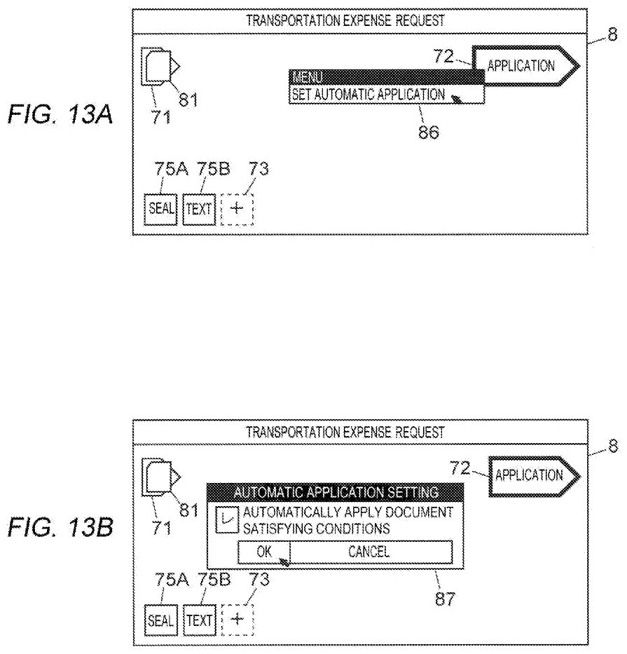

FIGS. 13A and 13B are diagrams illustrating an example of the workplace screen 8 and an example of an operation of setting an automatic application. The setting of the automatic application indicates that the application is set to be executed automatically when the document satisfies the termination condition. Here, the term “automatic” indicates that the application is executed even when the operator does not instruct the execution of the application.

When the receiving unit 200 receives the menu display operation of the transfer symbol 72, the display controller 209 displays a fifth menu screen 86 as illustrated in FIG. 13A. Next, when the receiving unit 200 receives an operation for the automatic application setting button displayed on the fifth menu screen 86, as illustrated in FIG. 13B, the display controller 209 displays an automatic application setting screen 87 that causes the operator to set whether the application is automatically executed. The setting unit 205 records information about the automation of the set application in the automation information table 223 of the storage unit 22 in association with information identifying the workplace and information identifying the operator.

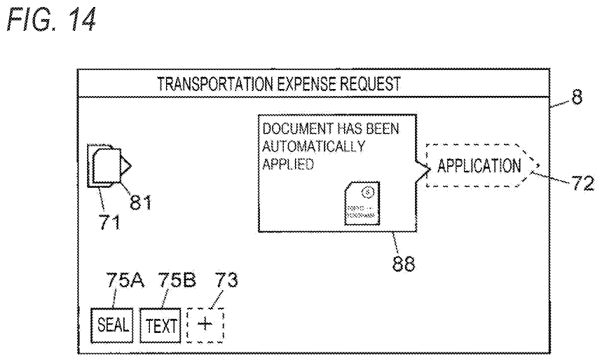

FIG. 14 is a diagram illustrating an example of the workplace screen 8 and an example of the operation of an automatic application execution. The phrase “automatic application execution” refers to executing an automatic application. The checking unit 208 confirms whether the document satisfies the termination condition recorded in the workplace information table 222 of the storage unit 22. When the checking unit 208 checks that the document satisfies the termination condition, the transfer unit 210 transfers the document from the workplace to another workplace associated with the workplace. Further, the display controller 209 may display, for example, a message 88 indicating that the document is automatically requested, as illustrated in FIG. 14. A document data symbol 82 indicated by a display mode indicating that various tasks are completed may be added to the message 88.

While exemplary embodiments of the present disclosure have been described above, it is to be understood that they are non-limiting, and various modifications and implementations may be made without departing from the gist of the present disclosure. For example, an operation display unit such as a touch panel display (not illustrated) may be provided in the information processing apparatus 2, and the display controller 209 may display a screen related to the screen information 225 on the display screen of the operation display unit.

In addition, the work flow is not limited to the above-mentioned application task or approval task, but may include various tasks related to the task of transferring a formal document. A work flow consisting of an application task and an approval task may be further linked to tasks such as communicating the contents approved by the approval task to the relevant department or recording the contents approved by the approval task in a predetermined place.

In the above-described exemplary embodiment, the construction of the work flow and the editing of the respective workplaces are separately performed. However, the order of the editing of the workplace and the construction (i.e., connection) of the work flow may be switched or may be alternately performed in parallel.

Further, in the above-described exemplary embodiment, the information of the sample document has been described as the document information 221 in the storage unit 22 in the information processing apparatus 2. However, the sample document transmitted from the terminal apparatus 3 (e.g., the administrator terminal apparatus 3A) may be received by the receiving unit 200.

When the controller 20 is provided with a transmitting unit (not illustrated) and the application document is requested at the first workplace, it is possible to transmit the notification information for notifying that the document is transferred to the second operator terminal apparatus 3B to be used by the second operator (approver) who operates the next workplace, that is, the second workplace related to the approval work. In this case, the information about the constructed work flow may be stored in the storage unit 22, and the transmitting unit may transmit the notification information to the terminal apparatus 3 related to the next workplace based on the information related to the work flow.

The display controller 209 may display a thumbnail related to the task that has been executed on the workplace screen 8 based on the information of the task progress information table 224. Further, the setting of the automatic task or the automatic application described above is not limited to the setting of each operator. The automatic task or the automatic application may be set, for example, in the editing of the workplace without depending on the operator.

The tool 226 is not limited to the above-described functions, and may include, for example, a function of deleting a record or the like which has been added to the task when a document is disclosed.

Each of the units of the controller 20 may be partially or entirely configured by hardware circuits such as a field programmable gate array (FPGA) or an application specific integrated circuit (ASIC).

In addition, it is possible to omit or change a portion of the constituent elements of the above-described exemplary embodiment within the scope of not changing the gist of the present disclosure. It is also possible to add, delete, modify, replace, etc. the steps in the flow of the above-described exemplary embodiment within the scope of not changing the gist of the present disclosure. Further, the program used in the above-described exemplary embodiment may be recorded on a computer-readable recording medium such as a CD-ROM, and may be stored in an external server such as a cloud server and used via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display controller that performs control in such a way that, in a series of processes including a first process to be executed on a document and a second process to be executed in association with the first process, a list of candidate functions for executing a process required for satisfying a condition necessary for transferring the document from the first process to the second process is displayed based on association information that associates the condition with a function of executing a process on the document.

2. The information processing apparatus according to claim 1, further comprising a selector for selecting a specific function from the list.

3. The information processing apparatus according to claim 2, wherein when the selector is used to select the specific function from the list, the display controller performs control in such a way that a list of candidate functions other than the specific function is displayed.

4. The information processing apparatus according to claim 3, wherein when a series of functions that satisfies the condition is selected, the display controller performs control in such a way that information indicating that a state capable of satisfying the condition is reached is displayed.

5. The information processing apparatus according to claim 4, further comprising an execution indicator for instructing execution of the functions,
wherein the display controller performs control in such a way that the execution indicator for the specific function is displayed in a highlighted manner as the information indicating that a state capable of satisfying the condition is reached.

6. The information processing apparatus according to claim 5, further comprising an execution unit that executes the function without an instruction by the execution indicator.

7. The information processing apparatus according to claim 6, wherein the execution unit executes a function of editing the document based on the condition.

8. The information processing apparatus according to claim 7, wherein the execution unit executes, as the function of editing the document, a function of inputting predetermined information to the document.

9. The information processing apparatus according to claim 8, further comprising a setting unit that sets the predetermined information.

10. A non-transitory computer readable medium storing a program causing a computer to execute information processing, the information processing comprising:
performing control in such a way that, in a series of processes including a first process to be executed on a document and a second process to be executed in association with the first process, a list of candidate functions for executing a process required for satisfying a condition necessary for transferring the document from the first process to the second process is displayed based on association information that associates the condition with a function of executing a process on the document.
